(19) United States
(12) Patent Application Publication
(10) Pub. No.: US 2013/0174037 A1
(43) Pub. Date: Jul. 4, 2013

(54) METHOD AND DEVICE FOR ADDING VIDEO INFORMATION, AND METHOD AND DEVICE FOR DISPLAYING VIDEO INFORMATION

(71) Applicant: Jianming Gao, Beijing (CN)

(72) Inventor: Jianming Gao, Beijing (CN)

(21) Appl. No.: 13/148,622

(22) PCT Filed: Apr. 29, 2011
(86) PCT No.: PCT/CN11/73518

§ 371 Date: Aug. 9, 2011

(30) Foreign Application Priority Data
Sep. 21, 2010 (CN) 201010290114.6

(51) Int. Cl. G06F 3/01

(52) U.S. Cl. CPC G06F 3/01
USPC 715/719

(57) ABSTRACT

A method and device for adding video information is provided in the present application. The method includes: selecting a starting and ending instant for adding commentary information, and selecting a frame of image between the starting instant and the ending instant; selecting a hotspot for adding the commentary information on the image, and obtaining extent information of the hotspot; editing the commentary information on the hotspot; and saving the commentary information, the extent information of the hotspot corresponding to the commentary information, and the starting and ending instant corresponding to the commentary information as a video commentary stream, and storing the video commentary stream in a server. The present application further provides a method and a device for displaying video information. By the embodiments of the present application, the video information can be displayed dynamically, and the user experience can be improved.

This application claims priority to Chinese Patent Application No. 201010290114.6, filed with the Chinese Patent Office on Sep. 21, 2010 and entitled “METHOD AND DEVICE FOR ADDING VIDEO INFORMATION, AND METHOD AND DEVICE FOR DISPLAYING VIDEO INFORMATION”, the entirety of which is incorporated by reference herein.

### FIELD OF THE INVENTION

The present invention relates to the field of video technique, and particularly to a method and device for adding video information, and a method and device for displaying video information.

### BACKGROUND OF THE INVENTION

With the increasing development of network technique, network video becomes more and more popular. When watching a video via network, a user may want to know some information about the video, such as the name of individual roles, the name of individual actors corresponding to individual roles. Taking TV series “A DREAM OF RED MANSIONS” for example, it is well known that there are numerous roles and quit complex relationship between the characters in “A DREAM OF RED MANSIONS”. Therefore, during watching “A DREAM OF RED MANSIONS”, the users are likely to forget the name of a certain role or want to know the information about the player of this role.

However, in the existing network video, the information of the video is generally displayed at a fixed segment of the video. For example, generally, the name of each role will be displayed when the role appears for the first time, and the name of individual actors corresponding to individual roles will be displayed at the opening or the ending of the video. If the user forgets the name of a certain role, it may be necessary to search the previous video to find out the time instant that this role appears for the first time; and if the user wants to know the information about a certain actor corresponding to a certain role, it is also necessary to further open a search page to obtain the information about this role by searching. Therefore, it is difficult for the user who is watching the current video to obtain the information about this video in real time so as to decrease the user experience.

### SUMMARY OF THE INVENTION

In view of this, the object of the present application is to provide a method and device for adding video information, and a method and device for displaying video information, for dynamically displaying the video information and improving the user experience.

To achieve the above objects, the present application provides a solution of a method for adding video information including:

selecting a starting instant and an ending instant for adding commentary information, and selecting a frame of image between the starting instant and the ending instant;

selecting a hotspot for adding the commentary information on the image, and obtaining extent information of the hotspot;

editing the commentary information on the hotspot; and

saving the commentary information, the extent information of the hotspot corresponding to the commentary information, and the starting and ending instant corresponding to the commentary information as a video commentary stream, and storing the video commentary stream in a server.

Preferably, before the step of editing the commentary information on the hotspot, the method further includes:

correcting the extent information of the hotspot according to all frames of image between the starting instant and the ending instant.

Preferably, the commentary information is a text, a hyperlink, or an associated address of the information text stored in the server.

Preferably, the video commentary stream is saved in the form of byte; and the video commentary stream has an identification corresponding to a video identification (ID).

The present application further provides a method for displaying video information including:

starting a video, and loading a video commentary stream corresponding to the video; and

detecting a pointing device in real time, and obtaining and displaying commentary information corresponding to the position that the pointing device is placed at the current instant.

Preferably, the step of detecting the pointing device in real time and obtaining and displaying the commentary information corresponding to the position where the pointing device is placed at the current instant includes:

step A: detecting the pointing device in real time, and obtaining position information of a cursor corresponding to the pointing device at the current instant;

step B: checking whether there is commentary information corresponding to the current instant in the video commentary stream, and, if there is commentary information corresponding to the current instant in the video commentary stream, going to step C, otherwise, going to step E;

step C: checking the commentary information corresponding to the current instant to determine whether a cursor position corresponding to the pointing device is contained in the extent of the hotspot of the commentary information, and if the cursor position corresponding to the pointing device is contained in the extent of the hotspot of the commentary information, then taking the commentary information of which the hotspot extent contains the cursor position corresponding to the pointing device as the commentary information corresponding to the position that the pointing device is placed at the current instant, and going to step D, otherwise, going to step E;

step D: displaying a commentary layer in the current played video, and displaying on the commentary layer the commentary information corresponding to the position that the pointing device is placed; and

step E: continuing playing the video.

Preferably, the commentary information corresponding to the current instant is the commentary information with a starting instant earlier than or equal to the current instant and an ending instant equal to or later than the current instant.

Preferably, in the step C, if it is determined that the cursor position corresponding to the pointing device is contained in the extent of the hotspot of the commentary information, then before going to the step D, the method further includes:

judging whether a dwell time of the pointing device in the extent of the hotspot of the commentary information corresponding to the position that the pointing device is placed is shorter than a predetermined shortest dwell time, and, if YES, going to the step E, otherwise, going to the step D.

Preferably, in the step D of displaying the commentary layer in the current displayed video and displaying on the commentary layer the commentary information corresponding to the position that the pointing device is placed, the method further includes:

pausing the video; and

stopping the display of the commentary layer and continuing playing the video, if it is detected that the cursor position corresponding to the pointing device moves out of the extent of the hotspot of the commentary information corresponding to the position that the pointing device is placed.

Preferably, after the step D, the method further includes:

stopping the display of the commentary layer, if it is detected that the cursor position corresponding to the pointing device moves out of the extent of the hotspot of the commentary information corresponding to the position that the pointing device is placed or if the current instant is later than the ending instant of the commentary information corresponding to the position that the pointing device is placed.

The present application further provides a device for adding video information, including:

an image selecting unit for selecting a starting and ending instant for adding commentary information, and selecting a frame of image between the starting instant and the ending instant;

a hotspot selecting unit for selecting a hotspot for adding the commentary information on the image, and obtaining extent information of the hotspot;

a commentary editing unit for editing the commentary information on the hotspot; and

a commentary stream saving unit for saving the commentary information, the extent information of the hotspot corresponding to the commentary information, and the starting and ending instant corresponding to the commentary information as a video commentary stream, and storing the video commentary stream in a server.

Preferably, the device further includes:

a correcting unit for correcting the extent information of the hotspot according to all frames of image between the starting instant and the ending instant.

The present application further provides a device for displaying video information, including:

a starting unit for starting a video and loading a video commentary stream corresponding to the video; and

a commentary displaying unit for detecting a pointing device in real time, and obtaining and displaying commentary information corresponding to the position that the pointing device is placed at the current instant.

Preferably, the commentary displaying unit includes:

a position detecting sub-unit for detecting the pointing device in real time, and obtaining position information of a cursor corresponding to the pointing device at the current instant;

a first searching sub-unit for checking whether there is commentary information corresponding to the current instant in the video commentary stream;

a second searching sub-unit for when the searching result of the first searching sub-unit is YES, checking the commentary information corresponding to the current instant to determine whether a cursor position corresponding to the pointing device is contained in the hotspot extent of the commentary information when the searching result of the first searching sub-unit is YES, and if a cursor position corresponding to the pointing device is contained in the extent of the hotspot of the commentary information, then the commentary information of which the hotspot extent contains the cursor position corresponding to the pointing device is taken as the commentary information corresponding to the position that the pointing device is placed at the current instant;

a commentary layer displaying sub-unit for displaying a commentary layer in the current displayed video and displaying on the commentary layer the commentary information corresponding to the position that the pointing device is placed, if the searching result of the second searching sub-unit is YES; and

a video playing sub-unit for continuing playing the video when the searching result of the first searching sub-unit is NO or if the searching result of the second searching sub-unit is NO.

Preferably, the commentary displaying unit further includes:

a first judging sub-unit for judging whether a dwell time of the pointing device in the extent of the hotspot of the commentary information corresponding to the position that the pointing device is placed is shorter than a predetermined shortest dwell time.

Preferably, the commentary displaying unit further includes:

a playing pausing sub-unit for pausing the video if the searching result of the second searching sub-unit is YES, and for stopping the display for the commentary layer and continuing playing the video if it is detected that the cursor position corresponding to the pointing device moves out of the extent of the hotspot of the commentary information corresponding to the position that the pointing device is placed.

Preferably, the device further includes:

a stopping commentary displaying unit for stopping the display of the commentary layer, if it is detected that the cursor position corresponding to the pointing device moves out of the extent of the hotspot of the commentary information corresponding to the position that the pointing device is placed or if the current time instant is later than the ending instant of the commentary information corresponding to the position that the pointing device is placed.

According to the specific embodiments provided by the present application, the present application discloses the following technical effects:

in the embodiments of the present application, the network video commentary stream corresponding to the video is saved in the server by performing information commenting on the network video. The video commentary stream corresponding to the video is loaded when the video is started. If the user wants to know the information about a certain object that appears on the video during watching the video, the user just needs to keep the pointing device in the extent corresponding to the object, and then the commentary information corresponding to this object will be displayed on the video image for the user. If the user does not want to check this commentary information, the user just needs to move the pointing device out of the extent corresponding to the object, and then the user can continue watching the video. Thus, the video information can be displayed dynamically according to the requirement of the user, and the user experience can be improved.

### BRIEF DESCRIPTION OF THE DRAWINGS

FIG. 1 is a flow chart of a method for adding video information according to the embodiment of the present application;

FIG. 2 is an illustrative diagram of a video information adding image according to the embodiment of the present application;

FIG. 3 is an illustrative diagram of an information editing box according to the embodiment of the present application;

FIG. 4 is a flow chart of a method for displaying video information according to a first embodiment of the present application;

FIG. 5 is a flow chart of a method for displaying video information according to a second embodiment of the present application;

FIG. 6 is an illustrative diagram of a commentary layer according to the embodiment of the present application;

FIG. 7 is a structural diagram of a device for adding video information according to the embodiment of the present application; and

FIG. 8 is a structural diagram of a device for displaying video information according to the embodiment of the present application.

### DESCRIPTION OF THE PREFERRED EMBODIMENTS

In view of this, the object of the present application is to provide a method and device for adding video information, and a method and device for displaying video information, for dynamically displaying the video information and improving the user experience.

To make the above object, feature and advantageous more apparent, the application will be further described in detail in combination with the drawings and the specific embodiments hereinafter.

In the embodiments of the present application, the video commentary stream corresponding to the video is saved in the server by performing information commentary for the network video. The video commentary stream corresponding to the video is loaded when the video is started. If during watching the video, the user wants to know the information about a certain object that appears on the video, the user just needs to keep the pointing device in the extent corresponding to the object, and then the commentary information corresponding to this object will be displayed on this video image for the user. If the user does not want to check this commentary information, the user just needs to move the pointing device out of the extent corresponding to the object, and then the user can watch the video continually. Thus, the video information can be displayed dynamically according to the requirement of the user, and the user experience can be improved.

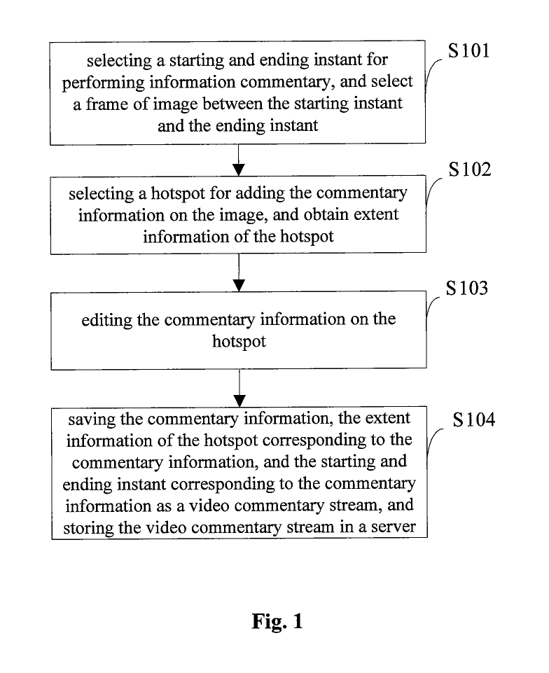

Referring to FIG. 1, a method for adding video information according to the a embodiment of the present application includes the following steps:

step S101: selecting a starting instant and an ending instant for performing information commentary, and selecting a frame of image between the starting instant and the ending instant.

When the information commentary is to be performed for a certain object of a video file in a certain period of time, firstly, the starting and ending instant is selected for the information commentary. Generally, the object to be commented keeps appearing on this video throughout the time period for performing the information commentary. Therefore, the starting and ending instant can be interpreted as the time period that the object to be commented appears on the video, and the time period that the object to be commented disappears from the video after the time period of continual appearance, respectively. For example, when a certain role on the video is to perform information commentary, firstly, it is necessary to determine the time period during which the role is to be commented. Generally, only if the role appears on the video, the information about the role will be provided to the user. Therefore, the time period that the role is to be commented can be set as the time period that the role appears on the video. Assumed that the role appears when the video goes to 7 min 20 sec and does not disappear until the video goes to 9 min 30 sec, then the starting instant for the information commentary of the role is set as “00:07:20” and the ending instant is set as “00:09:30”.

The video is composed of numerous and continuous video frames, one frame is one static image, and the continuous video frames consist of a dynamic video image. A frame of image is selected between the starting instant and the ending instant as a video frame. The object to be commented keeps displaying on the video all the time from the starting instant to the ending instant, so it can be determined that every frame between the starting instant and the ending instant has the object to be commented. Therefore, selecting a frame of image between the starting instant and the ending instant is to select an image of the object to be commented during this time period.

It is to be noted that, in the present application, the frame image can be selected arbitrarily between the starting instant and the ending instant.

Step S102: selecting a hotspot for adding the commentary information on the image, and obtaining extent information of the hotspot.

It is to be noted that the extent information of the hotspot is determined by the position of this hotspot on this image and the size of the hotspot.

In the method of the present application, the hotspot can be selected directly on the selected image by using a pre-configured pointing device (such as a mouse, a control lever, or an induction pen).

Specifically, the click information of the pointing device is received to determine the coordinate corresponding to each click of the pointing device. It is to be noted that the coordinate is the position of the pointing device on the video image. The extent information of the hotspot is obtained according to the coordinates which is respectively obtained by clicking the pointing device for many times. Preferably, the hotspot is generally of rectangle. However, in practice, the hotspot may be of any geometry, such as circle.

Taking the rectangle as an example, assuming that the coordinates corresponding to the two sequentially received clicks of the pointing device on the image is P1 and P2 respectively, and P2 is at the lower right of P1 (the abscissa of P2 is greater than that of P1, and the ordinate of P2 is less than that of P1), then the extent of the hotspot can be determined as a rectangle with P1 as the upper left apex and the P2 as the lower right apex. The coordinates of the other two apexes can be easily obtained according to the symmetric property of the rectangle, and then the position information of the hotspot is the coordinates of the four apexes of the rectangle.

After the hotspot is selected on the image, the position information of the hotspot can be obtained correspondingly. Taking the rectangle hotspot as an example, the position information of the hotspot is the coordinates of the four apexes of the hotspot on the video image. The hotspot is selected generally based on the object to be information commented. For example, to perform information commentary for a certain role on the video, the commentary information corresponding to the role should be added in the extent where the role appears on the video image.

Generally, the size of the hotspot is selected according to the size of the corresponding space occupied by the object on the currently selected image.

In the step S101, a frame of image can be selected arbitrarily between the starting instant and the ending instant. Preferably, to facilitate the selection of the hotspot, the selected image can be the image wherein the object to be commented is relatively clearly displayed or the image wherein a relatively single object is displayed.

The image wherein the object is relatively clearly displayed refers to: for example, if a certain role is to be commented, the image of the role with a clearer front can be selected. In other words, it should be avoided selecting the image wherein the object to be commented is relatively unclear or difficult to recognize, for example, the image wherein the role to be commented is far away, the image wherein the extent occupied by the role is small, and the image wherein the extent of the corresponding selected hotspot is also small. Therefore, once the extent of the hotspot is selected based on this image, for the other frames during this time period, it is hard to ensure that the object is still in the extent of the hotspot. Also for example, for the image wherein the object to be commented is in high speed moving or in fighting sequences, it may be very difficult to locate the role to decide the extent of the hotspot.

The image wherein a relatively single object is displayed refers to: such as the image including as few roles as possible. In other words, it should be avoided selecting the image including numerous roles, so as to locate the object to be commented easily. For example, for the image displaying a row of soldiers, it is very difficult to locate one of the soldiers as the object to be commented.

In the present application, the information commentary of the image is not only performed on a certain frame of image, but also need to add the commentary information onto each of the frames included in the time period between the starting instant and the ending instant. Therefore, preferably, when a hotspot is selected, not only the size of the space occupied by the object on the currently selected image, but also the size of the space occupied by the object on the video during this time period should be considered to determine the approximate extent that the object appears on the video during this time period as the hotspot.

In this way, the method of the present application further includes: correcting the extent of the hotspot according to all frames of image between the starting instant and the ending instant.

For example, in the frame of image selected in the step S101, only the front of the object to be information commented is displayed, and then according to this image, the extent that the hotspot can be selected is relatively large, to the extent of the size of the whole video displaying image. However, the other frame images between the starting instant and the ending instant may not be all full screen displaying of the object, in which the object may occupy only half or less of the video image. In this case, if the extent of the hotspot is set relatively large, then the commentary information corresponding to this object may also be displayed even when the pointing device is kept on other roles, and thus occurring a false displaying. Also for example, assuming that the hotspot extent selected according to a certain frame of image is too small, then for other frame of image, the object to be commented is probably out of the extent of this hotspot, so that the commentary information can not be displayed correctly when the pointing device of the user is kept on this object. To avoid the above cases, it is necessary to correct the extent of the hotspot according to the other frames of image between the starting instant and the ending instant.

Step S103: editing the commentary information on the hotspot.

The commentary information corresponding to the object to be information commented is edited on the hotspot. Specifically, the commentary information may be a text, a hyperlink, or an associated address of the information text stored in the server.

Taking the video of TV series “A DREAM OF RED MANSIONS” as an example, the user will probably forget the names of a certain role and the relationship between this role and the leading role, during watching “A DREAM OF RED MANSIONS”. Especially, in the new version of “A DREAM OF RED MANSIONS”, each of the roles is played by a new actor who is not familiar by the user. Thus, it is more difficult for the user to identify each of the roles. Therefore, in the method according to the embodiment of the present application, the name of the role, the name of the actor, the profile of the actor or the like can be commented on the hotspot. When the role appears on the video, the user can obtain the information about the role in the hotspot as necessary, so as to identify the roles conveniently and directly and improve the watching experience of the user.

The commentary information may be directly a text. For example, the name of the role, the information of the actor or the like is added directly onto this hotspot in the form of text information, and displayed directly for the user when the video is played. The commentary information may also be a hyperlink. For example, the URL address of a website related to this role is added onto this hotspot, and displayed for the user when the video is played. If the user wants to obtain the information about this role, the user just needs to click the URL address and thus directly access the corresponding web page.

Further, the information text can be pre-stored in the server, and the associated address of the information text can be added onto the hotspot as the commentary information. Still taking “A DREAM OF RED MANSIONS” as an example, duo to the complicated character relationships, it is very difficult for the user that is not familiar with the original to understand clearly the relationships between the characters. Therefore, a relationship list between the characters of “A DREAM OF RED MANSIONS” can be prepared and stored in the server as the information text corresponding to the roles. In the case of the information commentary for a certain role, the associated address (i.e., the storing address of the information text in the server) of the information text corresponding to the role only needs to be added onto the hotspot. Further, the associated address can be a hyperlink. For example, the associated address of the information text corresponding to the role “Jia Lian” can be displayed as “Jia Lian” on the hotspot. “Jia Lian” is displayed on the hotspot when the video is played, and if the user wants to know more information about the role “Jia Lian”, the user just needs to click the “Jia Lian” displayed on the hotspot, and then the text information corresponding to the role “Jia Lian” can be opened and the instruction to the role “Jia Lian” in detail can be obtained, for example, Jia Lian: the son of Jia She, the husband of Wang Xifeng, or the like.

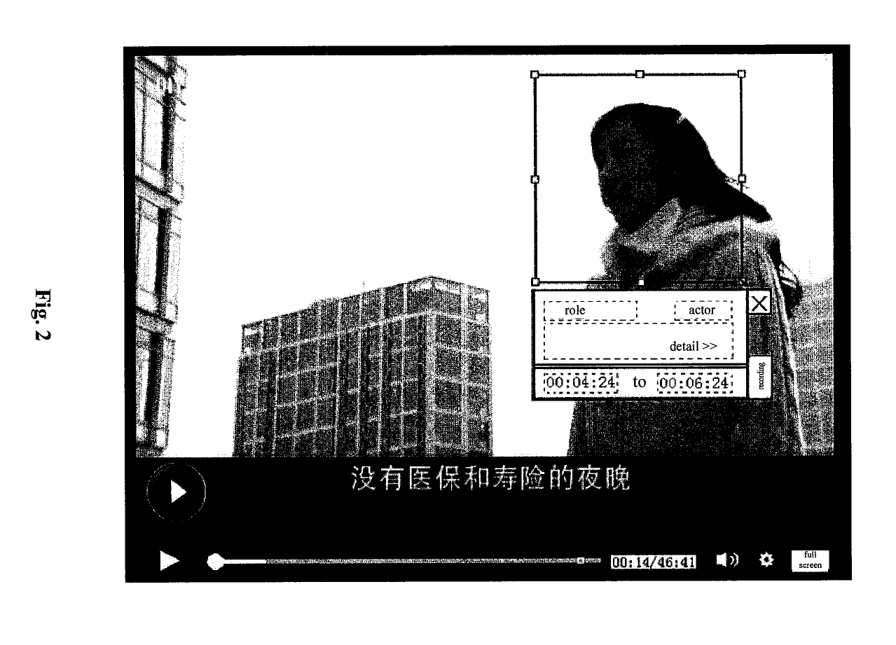

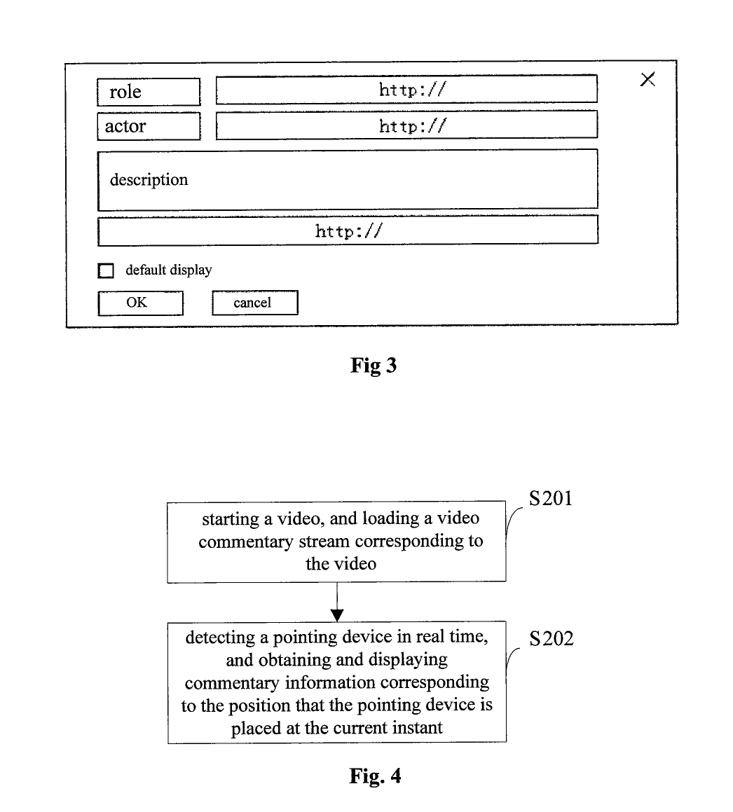

Specifically, the process of editing the commentary information on the hotspot is described in detail in combination with FIG. 2 and FIG. 3 which are illustrative diagrams of a video information adding image and an information editing box according to an embodiment of the present application, respectively.

As shown in FIG. 2, the character that appears on the image is the object to be commented. A suitable hotspot (the face region of the object to be commented in the figure) is selected in this image by using the pointing device, and the commentary information editing box is started. The commentary information editing box is shown in FIG. 3, in which the commentary information about the object is edited. After the editing is done, “OK” is clicked, and the commentary information will be displayed on the hotspot.

Referring to FIG. 3, the commentary information may be text information, which can be input in the “description” bar, and the text information edited in the commentary information editing box will be displayed directly on the hotspot. Preferably, all the text information can be displayed on the hotspot. However, in practice, due to the limited size of the video image, it is impossible to display all the text information on the hotspot when the content of the text information is more. In this case, only a part of the contents of the text information will be displayed on the hotspot, and the other contents will be hidden. Moreover, a corresponding button will be provided to display the hidden contents, such as the button “detail>>” in FIG. 2. If the user wants to check all the text information, the user just need to click the button “detail>>”, and then all the text information will be displayed.

The commentary information may also be hyperlink information, which can be input in “role” bar and the corresponding “http://” bar in the figure, and “role” is the description information of the hyperlink displayed for the user on the hotspot, and “http://” is URL of the hyperlink information. The description information (such as “role”) of the hyperlink is associated to the corresponding URL (such as “http://”) by the commentary information editing box. The hyperlink information edited in the commentary information editing box will display the description information of the hyperlink for the user on the hotspot, as shown in FIG. 2. When the user clicks the description information of the hyperlink displayed on the hotspot, the user will be automatically redirected to the web page denoted by the URL corresponding to the hyperlink. Preferably, a commentary information time box can also be displayed on the hotspot, which is used to display the starting instant and the ending instant corresponding to the commentary information, such as “00:04:24 to 00:06:24” shown in FIG. 2.

Furthermore, the starting instant and the ending instant corresponding to the commentary information can be modified through the commentary information time box.

Step S104: saving the commentary information, the extent information of the hotspot corresponding to the commentary information, and the starting instant and the ending instant corresponding to the commentary information as a video commentary stream, and storing the video commentary stream in a server.

The associated relationship among the commentary information, the extent information of the hotspot corresponding to the commentary information, and the starting and ending instant corresponding to the commentary information is established and saved in the video commentary stream.

Wherein the video commentary stream is saved in the form of byte.

After the commentary information is added onto the hotspot, the position information corresponding to the hotspot, the starting and ending time instant corresponding to the hotspot, and the commentary information corresponding to the hotspot are saved into the serve. The information corresponding to the hotspot can be saved in the form of byte, and referred to as a video commentary stream.

There is one-to-one corresponding relationship between video commentary streams and videos. Specifically, identification can be added to the video commentary stream, and identification of each video commentary stream corresponds to each video ID.

According to the method for adding video information provided by the embodiment of the present application, the correspondence between the video and the video commentary stream can be established by the following steps: selecting a frame of image from all the video frames in a certain time period; selecting from the image the hotspot that the commentary information is to be added; editing the commentary information corresponding to the video, on the hotspot; and saving the commentary information, the extent information of the hotspot corresponding to the commentary information, and the starting and ending instant corresponding to the commentary information as the video commentary stream, and storing the video commentary stream in a server. When the video is started, the video commentary stream corresponding to this video will be loaded. When the video is played to a certain instant, according to the user's requirement, the commentary information corresponding to the related hotspot on the frame of the video at this instant will be displayed for the user to improve the user experience.

An embodiment of the present application further provides a method for displaying video information. Referring to FIG. 4, the method for displaying video information provided by the first embodiment of the present application includes the following steps:

step S201: starting a video, and loading a video commentary stream corresponding to the video.

All the commentary information corresponding to the video, the extent information of the hotspot corresponding to the commentary information, and the starting and ending instant corresponding to the commentary information are saved in the video commentary stream.

The video commentary stream is saved on the server, and is a text in the form of byte. The video commentary stream has identification. There is one-to-one corresponding relation between identification of video commentary stream and video ID to ensure one-to-one corresponding relation between video commentary streams and videos.

Upon receiving the command from the user to start the video, the server starts the video, finds out the video commentary stream corresponding to this video by the ID of this video, and then loads the video commentary stream.

All the commentary information corresponding to the video, the extent information of the hotspot corresponding to the commentary information, and the starting and ending instant corresponding to the commentary information are saved in the video commentary stream.

It is to be noted that, there may be much corresponding commentary information for one video, such as the commentary information for different roles and the commentary information of the same role in different time period that this role is appeared on the video. The different commentary information is corresponding to the position information of the different hotspot, and the different starting and ending instant. For example, for role A and role B, the time periods that role A and role B are appeared on the video may be the same, but the positions of role A and role B on the video image will be different. Thus, the position of the commentary information corresponding to the role A is different from that corresponding to the role B. Alternatively, the major extent that the role A appears in the first time period can be same as or be different from that in the second time period. Therefore, for role A, the hotspot position information and the starting and ending instant in the corresponding commentary information in the first time period is different from that in the second time period.

Step S202: detecting a pointing device in real time, and obtaining and displaying commentary information corresponding to the position that the pointing device is placed at the current instant.

Specifically, the pointing device is the device pre-configured for triggering a video command, for example, an external device such as a mouse. For the external device such as the mouse, there is a corresponding cursor display on the computer screen, for example, the cursor display corresponding to the mouse is usually an arrow. The position information of the pointing device is the position information of the cursor corresponding to the mouse on the computer screen.

When watching the video, if the user wants to check the information about a certain role that appears on the currently played video, the user moves the pointing device to place or keep the pointing device on this role. Meanwhile, the position of the pointing device is obtained by detecting the pointing device in real time, and the video commentary stream saved in the server is searched to obtain the commentary information corresponding to the position that the pointing device is placed at the current instant and displayed the commentary information for the user.

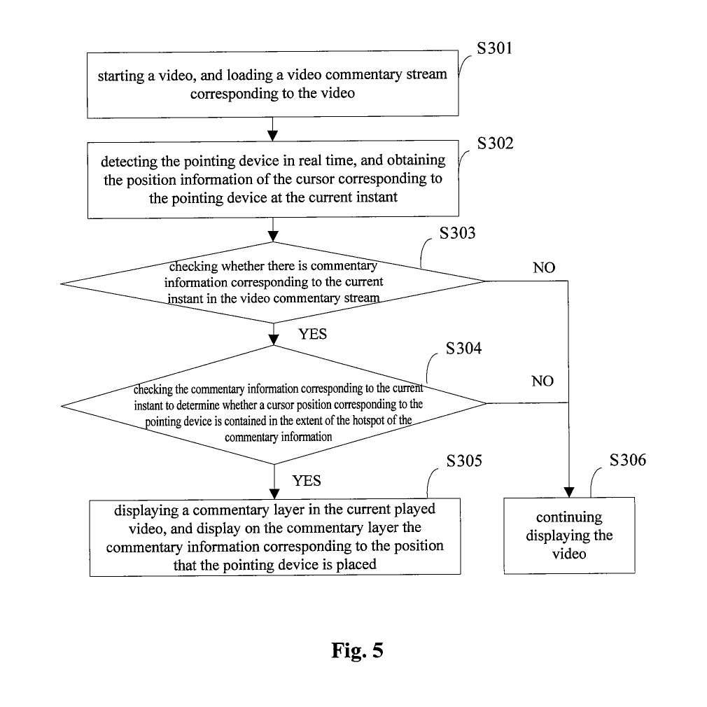

Referring to FIG. 5, a flow chart of a method for displaying video information according to a second embodiment of the present application is shown. In the second embodiment, the specific process of detecting the pointing device in real time and obtaining the commentary information corresponding to the position that the pointing device is placed at the current instant in step S202 is described in detail.

As shown in FIG. 5, specifically, the method for displaying video information according to the second embodiment includes:

step S301: starting a video, and loading a video commentary stream corresponding to the video;

step S302: detecting a pointing device in real time, and obtaining the position information of the cursor corresponding to the pointing device at the current instant;

step S303: checking whether there is commentary information corresponding to the current instant in the video commentary stream, and, if there is the commentary information corresponding to the current instant in the video commentary stream, going to step S304, otherwise, going to step S306;

specifically, the commentary information corresponding to the current instant is the commentary information with a starting instant earlier than or equal to the current instant and an ending instant equal to or later than the current instant.

The video commentary stream is checked and the individual commentary information saved in the video commentary stream is judged respectively, so as to determine whether there is commentary information with a starting instant earlier than or equal to the current instant and an ending instant equal to or later than the current instant. If there is commentary information with a starting instant earlier than or equal to the current instant and an ending instant equal to or later than the current instant, then all the commentary information that satisfies the above conditions are taken as the commentary information corresponding to the current instant.

Step S304: checking the commentary information corresponding to the current instant to determine whether a cursor position corresponding to the pointing device is contained in the hotspot extent of the commentary information, and if a cursor position corresponding to the pointing device is contained in the hotspot extent of the commentary information, then taking the commentary information of which the hotspot extent contains the cursor position corresponding to the pointing device as the commentary information corresponding to the position that the pointing device is placed at the current instant, and going to step S305, otherwise, going to step S306;

step S305: displaying a commentary layer in the currently played video, and displaying on the commentary layer the commentary information corresponding to the position that the pointing device is placed;

wherein the position and size of the commentary layer on the video is decided by the hotspot extent corresponding to the commentary information.

The commentary layer is a translucent covering layer covering the specific local extent of the video image. The commentary layer can be displayed on the video image to present it to the user, and the form for presenting the commentary layer is the same as that the setting information of the hotspot corresponding to the commentary information.

In order not to influence the viewing effect of the user, the covering layer can be set as a faintly visible extent outline, and the commentary information is displayed in this extent. When the pointing device clicks the corresponding hyperlink on the commentary information, the user will be redirected to the web page corresponding to the hyperlink. Furthermore, the commentary information can be set to be completely transparent, and the content of the commentary information is displayed only in the hotspot extent corresponding to the commentary information, so as to prevent the video image from being shielded and prevent the user from being affected.

Preferably, in the embodiment of the present application, when the commentary information is displayed, the commentary layer emerges only on the current video image without warming tone or the like, so as to prevent the user's watching the video from being affected.

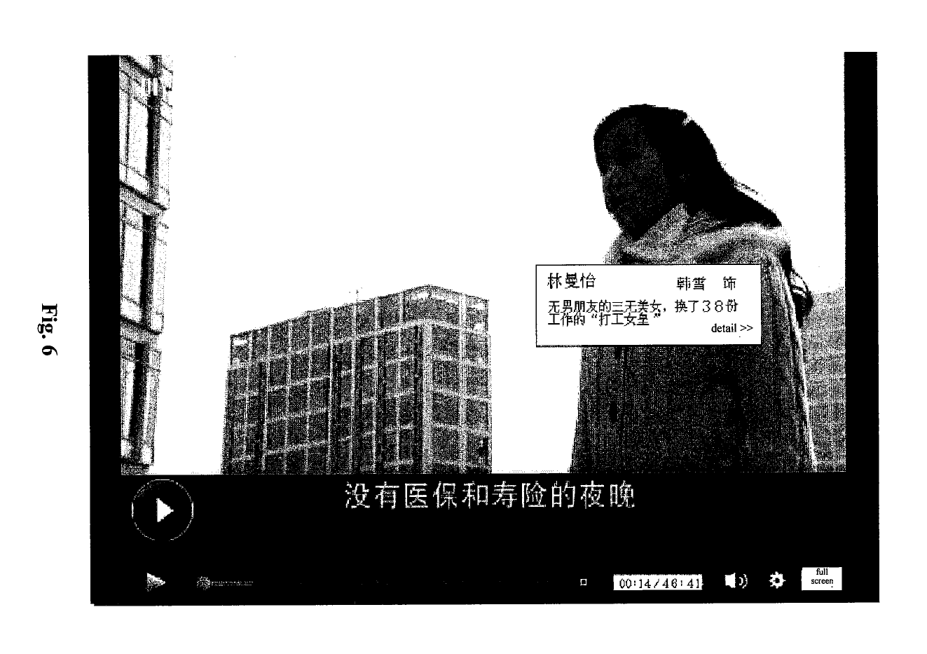

Referring to FIG. 6, an illustrative diagram of a commentary layer according to the embodiment of the present application is shown. As shown in FIG. 6, upon the commentary information corresponding to the position that the pointing device is placed at the current instant is found out, the commentary layer will be displayed in the specific local extent (that is the hotspot) of the current video image, the commentary information will be displayed on the commentary layer, and the commentary information may include the name of the role (such as “ [symbol] ” in FIG. 6), the name of the actor performing the role (such as “ [symbol] ” in FIG. 5), and the detail information corresponding to the role (such as “ [symbol] . . . ” in FIG. 6), in which “ [symbol] ” and “ [symbol] ” are hyperlink information. When “ [symbol] ” is clicked, the user will be automatically redirected to the web page denoted by the URL corresponding to “ [symbol] ”; “ [symbol] [symbol] . . . ” is text information; “detail>>” is used for hiding the entire text information, and “detail>>” will display all the text information for the user when clicked.

It is to be noted that, in the method provided by the embodiments of the present application, the display of the commentary layer in the currently played video will not affect the operation of the video play, namely, while the commentary layer is displayed on the video image, the user can still pause, start and end the video.

Step S306: going on playing the video.

For example, provided that the video is being displayed, and the current instant of the video is 00:04:19. The pointing device is detected, and the position P1 of the cursor corresponding to the pointing device at the instant 00:04:19 is obtained. It is judged whether there is a commentary information corresponding to the current instant in the video commentary stream, i.e., the commentary information with the starting instant earlier than or equal to 00:04:19 and the ending instant equal to or later than 00:04:19. It is assumed that two commentary information that satisfy the time conditions are obtained by searching, which are respectively:

commentary information 1: the starting instant of 00:02:31, the ending instant of 00:06:21, and the hotspot extent S1; and

commentary information 2: the starting instant of 00:04:02, the ending instant of 00:05:58, and the hotspot extent S2.

Then, it is judged which hotspot extent of the commentary information contains the position P1 of the pointing device at the current instant. If the position P1 falls into the hotspot extent S1 of the commentary information 1, then the commentary information 1 will be displayed on the commentary layer; and if the position P1 falls into the hotspot extent S2 of the commentary information 2, then the commentary information 2 will be displayed on the commentary layer.

Generally, when the hotspot extents corresponding to individual commentary information are set, if there are more than one piece of commentary information corresponding to the same instant, then the hotspot extents corresponding to individual commentary information are not overlapped, which device that the hotspot extents corresponding to individual commentary information are independent with each other, and have no common region.

Preferably, after the step S305, the method further includes:

stopping the display of the commentary layer, when it is detected that the cursor position corresponding to the pointing device is out of the hotspot extent of the commentary information corresponding to the position that the pointing device is placed or when the current instant is later than the ending instant of the commentary information corresponding to the position that the pointing device is placed.

Sometimes, during the user views the video, the move of the pointing device does not means to check the commentary information of the current video. In this case, the pointing device may just slide across the video quickly, and if the commentary information is displayed for the user under this condition, the user's viewing may be affected and the user may feel uncomfortable.

Preferably, in the step S304 of the method according to the present application, if it is determined that cursor position corresponding to the pointing device is contained in the hotspot extent of the commentary information, then before going to the step S305, the method further includes:

judging whether a dwell time of the pointing device in the hotspot extent of the commentary information corresponding to the position that the pointing device is placed is shorter than a predetermined shortest dwell time, and, if YES, going to the step S306, otherwise, going to the step S305.

Therefore, if the dwell time of the pointing device in the hotspot extent of the commentary information is shorter than the predetermined shortest residence time, it indicates that the pointing device may just slide across the video image quickly, i.e., the pointing device may just slide across the hotspot extent of the commentary information quickly without any stops. For this case, it can be considered that the user does not want to check the commentary information corresponding to the current instant. In order to prevent the viewing of the user from being affected, the video will still be displayed normally and the commentary information will not be displayed for the user.

If the commentary information corresponding to the position that the pointing device is placed at the current instant is found out and is displayed for the user, and the video is still being displayed normally meanwhile, then in order to check the commentary information, the user may be too busy to watch the video, and the user viewing experience will be affected.

Preferably, to facilitate the checking of the commentary information by the user and avoid affecting the viewing process of the user, in the step S305, while displaying a commentary layer in the currently played video and displaying on the commentary layer the commentary information corresponding to the position that the pointing device is placed, the method further includes:

pausing the playing of the video, and when it is detected that the cursor position corresponding to the pointing device moves out of the hotspot extent of the commentary information, stopping displaying the commentary layer and going on playing the video.

When the commentary information is displayed for the user, the video is paused, so that the user can intent on checking the commentary information, and does not have to worry about missing the content of the video. When it is detected that the pointing device moves out of the hotspot extent of the commentary information, which indicates that the user does not want to check the commentary information any more, the displaying of the commentary layer is stopped, and the video is played for the user continuously.

According to the method for displaying video information provided by the embodiments of the present application, the video commentary stream corresponding to the video is saved in the server by performing information commentary on the network video. The video commentary stream corresponding to the video is loaded when the video is started. If the user wants to know the information about some objects that appear on the video during watching the video, the user just need to keep the pointing device in the extent corresponding to the object, and then the commentary information corresponding to this object will be displayed for the user on the video image. If the user does not want to check this commentary information, the user just need to move the pointing device out of the extent corresponding to the object, and then the user can continue viewing the video. Thus, the video information can be displayed dynamically according to the requirement of the user, and the user experience can be improved.

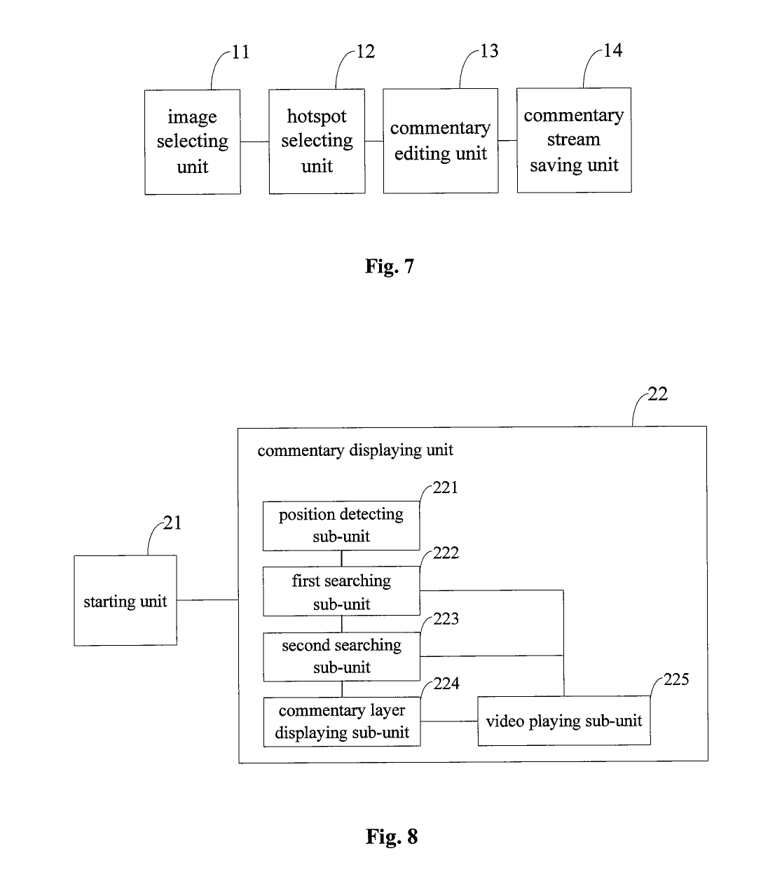

Corresponding to the method for adding video information provided by the embodiments of the present application, an embodiment of the present application further provides a device for adding video information. Referring to FIG. 7, a structural diagram of the device for adding video information according to the embodiment of the present application is shown.

The device for adding video information includes:

an image selecting unit 11 for selecting a starting and ending instant for adding commentary information, and selecting a frame of image between the starting instant and the ending instant;

a hotspot selecting unit 12 for selecting a hotspot for adding the commentary information on the image, and obtaining extent information of the hotspot;

a commentary editing unit 13 for editing the commentary information on the hotspot; and

a commentary stream saving unit 14 for saving the commentary information, the extent information of the hotspot corresponding to the commentary information, and the starting and ending instant corresponding to the commentary information as a video commentary stream, and storing the video commentary stream in a server.

Preferably, the device may further include a correcting unit for correcting the extent information of the hotspot according to all frames of image between the starting instant and the ending instant.

Preferably, the commentary information is a text, a hyperlink, or an associated address of the information text stored in the server.

Preferably, the video commentary stream is saved in the form of byte; and the video commentary stream has an identification corresponding to the video identification.

Corresponding to the method for displaying video information provided by the embodiments of the present application, an embodiment of the present application further provides a device for displaying video information. Referring to FIG. 8, a structural diagram of the device for displaying video information according to the embodiment of the present application is shown.

The device for displaying video information includes:

a starting unit 21 for starting a video and loading a video commentary stream corresponding to the video; and

a commentary displaying unit 22 for detecting a pointing device in real time, and obtaining and displaying commentary information corresponding to the position that the pointing device is placed at the current instant.

Preferably, the commentary displaying unit 22 may include:

a position detecting sub-unit 221 for detecting the pointing device in real time, and obtaining position information of a cursor corresponding to the pointing device at the current instant;

a first searching sub-unit 222 for checking whether there is commentary information corresponding to the current instant in the video commentary stream;

preferably, the commentary information corresponding to the current instant refers to the commentary information with a starting instant earlier than or equal to the current instant and an ending instant equal to or later than the current instant;

a second searching sub-unit 223 for when the searching result of the first searching sub-unit 222 is YES, checking the commentary information corresponding to the current instant to determine whether a cursor position corresponding to the pointing device is contained in the hotspot extent of the commentary information, and if a cursor position corresponding to the pointing device is contained in the hotspot extent of the commentary information, the commentary information of which the hotspot extent contains the cursor position corresponding to the pointing device is taken as the commentary information corresponding to the position that the pointing device is placed at the current instant;

a commentary layer displaying sub-unit 224 for displaying a commentary layer in the current displayed video and displaying on the commentary layer the commentary information corresponding to the position that the pointing device is placed, if the searching result of the second searching sub-unit 223 is YES; and

a video playing sub-unit 225 for continuing playing the video when the searching result of the first searching sub-unit 222 is NO or if the searching result of the second searching sub-unit 223 is NO.

Preferably, the commentary displaying unit 22 may further include:

a first judging sub-unit for judging whether the dwell time of the pointing device staying in the extent of the hotspot of the commentary information corresponding to the position that the pointing device is placed is shorter than the predetermined shortest dwell time.

Preferably, the commentary displaying unit 22 may further include:

a playing pausing sub-unit for pausing the video if the searching result of the second searching sub-unit 223 is YES; and for stopping the display of the commentary layer and continuing playing the video, if it is detected that the cursor position corresponding to the pointing device moves out of the extent of the hotspot of the commentary information corresponding to the position that the pointing device is placed.

Preferably, the device may further include:

a stopping commentary displaying unit for stopping the display of the commentary layer, if it is detected that the cursor position corresponding to the pointing device moves out of the extent of the hotspot of the commentary information corresponding to the position that the pointing device is placed or if the current instant is later than the ending instant of the commentary information corresponding to the position that the pointing device is placed.

The method and device for adding video information, and the method and device for displaying video information provided by the present application are described in detail above. In the present application, the principle and the embodiments of the present application are described by specific examples, and the above embodiments are only for facilitating the understanding of the method of the present application and the basic idea thereof; meanwhile, modifications and variations can be made to the specific embodiments and the application scope by those skilled in the art according to the spirit of this application. Summarily, the content of the present description should not be construed as limitations to the present application.

What is claimed is:

1. A method for adding video information, comprising:
selecting a starting and ending instant for adding commentary information, and selecting a frame of image between the starting instant and the ending instant;
selecting a hotspot for adding the commentary information on the image, and obtaining extent information of the hotspot;
editing the commentary information on the hotspot; and
saving the commentary information, the extent information of the hotspot corresponding to the commentary information, and the starting and ending instant corresponding to the commentary information as a video commentary stream, and storing the video commentary stream in a server.

2. The method according to claim 1, wherein before the step of editing the commentary information on the hotspot, the method further comprises:
correcting the extent information of the hotspot according to all frames of image between the starting instant and the ending instant.

3. The method according to claim 1, wherein the commentary information is a text, a hyperlink, or an associated address of the information text stored in the server.

4. The method according to claim 1, wherein the video commentary stream is saved in the form of byte; and the video commentary stream has an identification corresponding to a video identification (ID).

5. A method for displaying video information, comprising:
starting a video, and loading a video commentary stream corresponding to the video; and
detecting a pointing device in real time, and obtaining and displaying commentary information corresponding to the position that the pointing device is placed at the current instant.

6. The method according to claim 5, wherein the step of detecting the pointing device in real time and obtaining and displaying the commentary information corresponding to the position that the pointing device is placed at the current instant comprises:
step A: detecting the pointing device in real time, and obtaining position information of a cursor corresponding to the pointing device at the current instant;
step B: checking whether there is commentary information corresponding to the current instant in the video commentary stream, and if there is commentary information corresponding to the current instant in the video commentary stream, going to step C, otherwise, going to step E;
step C: checking the commentary information corresponding to the current instant to determine whether a cursor position corresponding to the pointing device is contained in the extent of the hotspot of the commentary information, and if the cursor position corresponding to the pointing device is contained in the extent of the hotspot of the commentary information, then taking the commentary information of which the hotspot extent contains the cursor position corresponding to the pointing device as the commentary information corresponding to the position that the pointing device is placed at the current instant, and going to step D, otherwise, going to step E;
step D: displaying a commentary layer in the current played video, and displaying on the commentary layer the commentary information corresponding to the position that the pointing device is placed; and
step E: continuing playing the video.

7. The method according to claim 6, wherein the commentary information corresponding to the current instant is the commentary information with a starting instant earlier than or equal to the current instant and an ending instant equal to or later than the current instant.

8. The method according to claim 6, wherein in the step C, if it is determined that the cursor position corresponding to the pointing device is contained in the extent of the hotspot of the commentary information, then before going to the step D, the method further comprises:
judging whether a dwell time of the pointing device in the extent of the hotspot of the commentary information corresponding to the position that the pointing device is placed is shorter than a predetermined shortest dwell time, and, if YES, going to the step E, otherwise, going to the step D.

9. The method according to claim 6, wherein in the step D of displaying the commentary layer in the current displayed video and displaying on the commentary layer the commentary information corresponding to the position that the pointing device is placed, the method further comprises:
pausing the video; and
stopping the display of the commentary layer and continuing playing the video, if it is detected that the cursor position corresponding to the pointing device moves out of the extent of the hotspot of the commentary information corresponding to the position that the pointing device is placed.

10. The method according to claim 6, wherein after the step D, the method further comprises:
stopping the display of the commentary layer, if it is detected that the cursor position corresponding to the pointing device moves out of the extent of the hotspot of the commentary information corresponding to the position that the pointing device is placed or if the current instant is later than the ending instant of the commentary information corresponding to the position that the pointing device is placed.

11. A device for adding video information, comprising:
an image selecting unit for selecting a starting and ending instant for adding commentary information, and selecting a frame of image between the starting instant and the ending instant;
a hotspot selecting unit for selecting a hotspot for adding the commentary information on the image, and obtaining extent information of the hotspot;
a commentary editing unit for editing the commentary information on the hotspot; and
a commentary stream saving unit for saving the commentary information, the extent information of the hotspot corresponding to the commentary information, and the starting and ending instant corresponding to the commentary information as a video commentary stream, and storing the video commentary stream in a server.

12. The device for adding video information according to claim 11, wherein the device further comprises:
a correcting unit for correcting the extent information of the hotspot according to all frames of image between the starting instant and the ending instant.

13. A device for displaying video information, comprising:
a starting unit for starting a video and loading a video commentary stream corresponding to the video; and
a commentary displaying unit for detecting a pointing device in real time, and obtaining and displaying commentary information corresponding to the position that the pointing device is placed at the current instant.

14. The device for displaying video information according to claim 13, wherein the commentary displaying unit comprises:
a position detecting sub-unit for detecting the pointing device in real time, and obtaining position information of a cursor corresponding to the pointing device at the current instant;
a first searching sub-unit for checking whether there is commentary information corresponding to the current instant in the video commentary stream;
a second searching sub-unit for when the searching result of the first searching sub-unit is YES, checking the commentary information corresponding to the current instant to determine whether a cursor position corresponding to the pointing device is contained in the extent of the hotspot of the commentary information, wherein if a cursor position corresponding to the pointing device is contained in the extent of the hotspot of the commentary information, the commentary information of which the hotspot extent contains the cursor position corresponding to the pointing device is taken as the commentary information corresponding to the position that the pointing device is placed at the current instant;
a commentary layer displaying sub-unit for displaying a commentary layer in the current displayed video and displaying on the commentary layer the commentary information corresponding to the position that the pointing device is placed, if the searching result of the second searching sub-unit is YES; and
a video playing sub-unit for continuing playing the video if the searching result of the first searching sub-unit is NO or if the searching result of the second searching sub-unit is NO.

15. The device for displaying video information according to claim 14, wherein the commentary displaying unit further comprises:
a first judging sub-unit for judging whether a dwell time of the pointing device in the extent of the hotspot of the commentary information corresponding to the position that the pointing device is placed is shorter than a predetermined shortest dwell time.

16. The device for displaying video information according to claim 14, wherein the commentary displaying unit further comprises:
a playing pausing sub-unit for pausing the video if the searching result of the second searching sub-unit is YES; and for stopping the display of the commentary layer and continuing playing the video if it is detected that the cursor position corresponding to the pointing device moves out of the extent of the hotspot of the commentary information corresponding to the position that the pointing device is placed.

17. The device for displaying video information according to claim 14, wherein the device further comprises:
a stopping commentary displaying unit for stopping the display of the commentary layer, if it is detected that the cursor position corresponding to the pointing device moves out of the extent of the hotspot of the commentary information corresponding to the position that the pointing device is placed or if the current instant is later than the ending instant of the commentary information corresponding to the position that the pointing device is placed.
